(19) United States
(12) Patent Application Publication
(10) Pub. No.: US 2022/0008755 A1
(43) Pub. Date: Jan. 13, 2022

(54) MICRO FLOW REGULATOR AND BREATHING HOOD SYSTEM USING SAME

(71) Applicant: ESSEX INDUSTRIES, INC., St. Louis, MO (US)

(72) Inventor: William C. Dean, Valley Park, MO (US)

(21) Appl. No.: 16/925,765

(22) Filed: Jul. 10, 2020

(51) Int. Cl. A62B 7/02; A62B 18/04; A62B 9/02

(52) U.S. Cl. CPC A62B 7/02; A62B 9/02; A62B 18/04

(57) ABSTRACT

A breathing apparatus provides gas within a hood surrounding a user's head from two oxygen tanks which each utilize a regulator. The first tank serves to inflate the hood while the second provides oxygen to the hood at a sufficient amount for human breathing for a longer time than traditionally available for such hoods. The longer life is provided through the use of micro regulators which utilize micro springs or wave washers and micro machining techniques to regulate the flow of oxygen in a way that has not been previously possible.

### BACKGROUND OF THE INVENTION

### Field of the Invention

This invention relates to a gas regulator. Particularly to a gas regulator for a self contained emergency breathing apparatus, specifically a breathing apparatus comprising a hood surrounding a user's head and sealed about the user's neck.

### Description of the Related Art

Concerns over exposure to chemical or biological contaminants has prompted an increased interest in the effectiveness of breathing apparatuses that can be used in an emergency to allow emergency personnel to operate in a contaminated area, or to allow for protection of occupants during the evacuation of a contaminated building or mass transit vehicle. These concerns are particularly heightened in passenger aircraft where the nature of the environment provides heightened levels of concern about exposure to potentially harmful chemicals, such as from a fire, or can simply be used to provide oxygen in a depressurized aircraft cabin.

While some types of breathing apparatuses already exist for passengers on aircraft, they often fall short of meeting desired performance characteristics for personnel that need to carry out essential tasks during an emergency which compromises the environment of an aircraft. For pilots and flight attendants onboard an aircraft, it is imperative that they be able to both breathe and carry out emergency procedures in the event of a fire or decompression on the aircraft. While individual passengers passing out, suffering the effects of smoke inhalation, or even dying in an aircraft fire is unquestionably tragic, should the pilots and other aircraft personnel become incapacitated, a resulting crash or larger loss of life that could occur from that incapacitation will typically be much worse.

Because of the concerns of incapacitation of critical aircraft personnel, pilots and others are often provided with individual emergency breathing apparatus for short-term use in a fire, decompression, or other situation where the gas inside the aircraft has become compromised. These are often referred to colloquially as “smoke hoods” but are more formally known as “protective breathing equipment” or simply “PBEs”. PBEs, or devices like them, are also starting to see use as potential emergency equipment in other environments where a relatively small window of breathing protection could allow for dramatic reduction in the severity of an emergency or allow for escape from a dangerous environment.

Many emergency breathing apparatuses and specifically PBEs include a hood that encloses a user's head and which not only aids in protecting sensitive areas about the face and within the respiratory system, but also allows the elimination of any mouth bit or cup. This makes them self-contained on the user, simple and easy to use, and allows the user a degree of comfort enabling users to see and act more calmly. It also makes them lightweight for storage onboard an aircraft and, since the hood is flexible, makes it easy to see when the systems are running out of gas for the user as the hood will typically collapse about the head instead of being inflated.

In PBEs, the hood is typically maintained at positive pressure. This provides for a number of benefits. Specifically, having the hood at positive pressure inhibits external gases (which may be toxic or at least irritating) from entering the hood while it is being used and it helps maintain the integrity of the system. Maintaining the hood at a positive pressure also assists in use of the hood as it is not required that a user correctly and fully seal the hood from the environment. This can make donning the hood simpler and quicker.

Positive pressure can also assist users in feeling comfortable with the hood, as while their head is technically within a small enclosed bag (which everyone is taught from birth can be negative), the hood does not feel constricting when the hood is inflated. Similarly, it can make it simpler to determine when the hood is running out of gas as deflation of the hood is relatively obvious and readily noticed by the user and those around them.

In the aircraft environment, it is important to recognize that PBEs, while undeniably necessary and useful in an emergency, impart a non-zero cost on every flight. The weight of an aircraft is more directly related to fuel consumption than it is in virtually any other environment and while multiple PBEs should be carried on every flight, they are only very rarely needed and used. Because of this, the weight of a PBE is typically very rigidly controlled and is usually set to be no more than a fixed amount which is often around 2 kg.

The weight and bulk of a PBE is generally best considered as two separate components. The first is the weight and bulk of the physical structure of the PBE. This is the weight taken up by the operational parts of the PBE such as the hood structure, the oxygen tank structure, and other infrastructure required for the PBE to operate and be stored. The second component is the actual weight of the oxygen or oxygen source material. Traditional thinking has been that if weight of the components of a PBE can be decreased, that weight can be used to increase oxygen supply which increases the operational life of the device without increasing the net weight. Thus, reduction of weight of the other components (not the oxygen) is often paramount.

In order to reduce weight, the oxygen tanks in PBEs are typically designed for the specific purpose of the PBE. In the first instance, they typically are filled with oxygen at extremely high pressure. This can allow for a relatively small tank to supply a good amount of oxygen. Higher pressure oxygen, by supplying a longer life for the same physical size tank, means that a smaller tank can be used to provide the same life. This will typically save weight and bulk which can be utilized elsewhere in the PBE. Further, very high pressure tanks, while they may require more material to survive the pressure requirements, often actually utilize less material in their construction than larger lower pressure tanks.

Secondly, in order to provide more oxygen per weight, PBEs typically utilize two small oxygen tanks in a typically self-contained arrangement where the two tanks have very different purposes during PBE operation. The first tank is typically designed to rapidly supply oxygen to the hood upon the hood being deployed to create positive pressure but not supply a steady stream of breathable oxygen after the hood is donned. Discharge of the first tank, therefore, typically results in rapid inflation of the hood and establishment of the positive pressure environment inside the hood when the hood is first donned, but the first tank will rapidly run out of oxygen after that.

The second tank is designed to supply a more steady supply of oxygen to the hood after initial inflation to maintain the hood environment and protect breathing for the user for a period of time. The second tank, therefore, will typically supply oxygen at a substantially lower rate than the first. This second rate is therefore typically targeted to be about the amount of oxygen the user will be removing from the gas by respiration.

The second rate is particularly important because the rate of exhaustion and total size of the second tank will typically determine the operational time of the hood. Basically, if the second rate is chosen so that gas is exhausted from the tank to the hood at exactly the speed oxygen is consumed by the user and the rate that gas is lost to maintain the positive pressure, the operational life (the amount of time the hood can provide a safe breathing environment for the user) is theoretically maximized. Thus, if this rate is correctly chosen, the PBE will provide a safe environment for as long as it can within its other design parameters. The first tank, while it supplies initial pressurization, is typically exhausted early in the use of the hood, and, therefore, contributes little to the operational life.

In order to save weight, PBEs have not used regulators on the oxygen flow in either tank. Instead, oxygen flow from the tank to the PBE has essentially been controlled simply by the size of aperture through which it is dispensed from the tank. These apertures are simply opened or formed when the PBE is used, and the flow from both the first and second tank is based on the size of aperture in each tank, which are typically different from each other.

What that means is that the first fill tank, which is used to supply the initial pressurization, will simply have a larger access hole from the tank to fill the hood at a rate higher than the user will breathe it in and that the first tank will supply this amount until the tank is empty. Thus, the first tank typically needs to be specifically sized to provide sufficient oxygen for initial inflation (pressurization), but the first tank does little to assist in operational use. Oxygen from the first tank, above what is needed to inflate the PBE will typically be wasted, since, without a regulator, the tank will pump the hood too full resulting in the excess oxygen simply exhausting through seals, overpressure valves or, in a worst case scenario, rupturing the hood or other components. At the same time, if the tank is too small, the hood may not inflate to the desired positive pressure, or, if it is not donned correctly sufficiently quickly, the hood may not correctly obtain a sufficiently high pressure at all.

The second tank, which is typically used to supply breathing oxygen as the hood is in use, also will lack a regulator. Thus, it will also simply supply the oxygen through the aperture until the tank is empty. This will typically be a rate below that of the first tank and which is sized based on expected consumption and maintenance of desired pressure. The problem with an aperture, however, is that the rate that the oxygen is discharged over time once the aperture is opened is not constant. Because the oxygen is under pressure, after oxygen begins to depart the second tank, the pressure in the second tank will decrease. This decrease in pressure will cause the flow of oxygen from the tank to decrease. Thus, over time, the flow of oxygen from the second tank will constantly decrease. This is illustrated in the present FIG. 6 which shows how use of an aperture without a regulator results in most of the gas being provided at the beginning of the flow and the amount of gas towards the end of the flow is generally substantially less and often insufficient to allow continued use.

As should be apparent from the above, the tanks and oxygen supplies in current PBEs which lack regulators need to have a built-in margin for error on the size of discharge holes selected for the oxygen tanks. Typically, this means that they will supply too much oxygen when the tank is first donned in order to supply sufficient oxygen later and provide sufficient useful life to be workable. Thus, the systems will near universally waste oxygen. However, pressurized oxygen is rather lightweight compared to traditional regulators and related components and, thus, regulators have been seen as unnecessary weight which can be eliminated to increase the oxygen supply to provide longer life. This design will typically mean that the tanks need to be bigger than necessary and that the systems are built with wastefulness in mind, but may still provide a longer effective life than if they were not.

The best way to eliminate this wastefulness of oxygen would be to supply the PBE with a regulator on one or both of the oxygen tanks. Regulators, however, have traditionally been bulky and heavy and are not designed to work with devices where weight and bulk are paramount. Thus, prior regulators have been unusable because they cannot save oxygen in sufficient amount to offset the oxygen tank volume lost from the weight of the regulator when included in a PBE or similar device.

### SUMMARY OF THE INVENTION

The following summary of the invention is provided to give the reader a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented in a later section.

Because of these and other problems in the art, described herein are regulators designed to be used in weight and bulk sensitive environments such as in aircraft protective breathing equipment (PBE) or a similar a breathing apparatus providing breathable gas within a hood surrounding a user's head.

There is also described herein, in an embodiment, a breathing apparatus for providing a user with a breathable atmosphere, such breathable atmosphere being generally isolated from a potentially hazardous external environment, said apparatus comprising: a hood capable of surrounding a user's head, said hood having an internal volume therein; a first oxygen source including a first amount of pressurized oxygen to said hood via a first regulator, said first regulator providing a first rate of said first amount of oxygen; and a second oxygen source including a second amount of pressurized oxygen to said hood via a second regulator, said second regulator providing a second rate of said second amount of oxygen; wherein, said first rate is greater than said second rate; wherein, said first amount of oxygen is depleted before said second amount of oxygen; and wherein, said second rate supplies sufficient oxygen from said first tank to allow a human to breathe from said hood for at least 600 seconds.

### BRIEF DESCRIPTION OF THE DRAWINGS

FIG. 1 provides a basic perspective view of an embodiment of a personal breathing equipment (PBE) suitable for use on an aircraft,

FIG. 2 provides a side cutaway view of an embodiment of a microregulator using a micro compression spring.

FIG. 3 provides a side cutaway view of an embodiment of a microregulator using a wave washer array.

FIG. 4 provides an indication of outlet versus inlet pressure for the regulator of FIG. 2.

FIG. 5 provides an indication of outlet versus inlet pressure for the regulator of FIG. 3.

FIG. 6 provides a graph showing the gas pressure within a hood utilizing regulators of the present disclosure versus unregulated flow from the same pressure of cylinders.

### DETAILED DESCRIPTION OF PREFERRED EMBODIMENTS

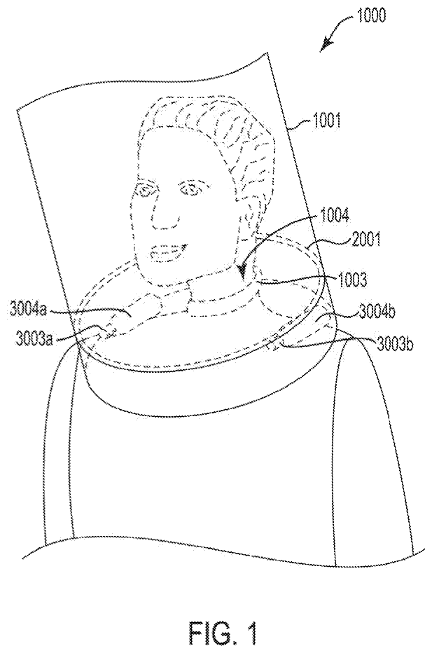

An embodiment of a breathing apparatus (1000) is shown in FIG. 1, and generally comprises a hood (1001) and a housing (2001). The hood (1001) surrounds the user's head and contains a breathable atmosphere. The housing (2001) holds elements that function to provide gas purification and/or oxygen enrichment for the atmosphere within the hood (1001), thereby providing support for the respiration of the user wearing the hood (1001). Such a breathing apparatus (1000) is designed to provide protection from dangerous external environments, such as are presented by, though not limited to, smoke or fire, or chemical, biological, radiological or nuclear hazards, that might otherwise negatively impact any or all of the biological and physiological functions central to a user's head, such as sight and respiration and so many other bodily functions that can be detrimentally impacted by inhaled hazards.

An aspect of the apparatus (1000) is a hood (1001) that is large enough to surround a person's head. The hood (1001) is constructed at least in part of a transparent or translucent material through which the user can see when wearing the hood (1001). The hood (1001) includes a neck seal subassembly (1003), which provides an opening (1004) through which a user's head is moved when donning the hood (1001). In an embodiment, the neck seal subassembly (1003) functions like an elastomeric membrane allowing the opening (1004) to expand to allow a user's head into the hood (1001) and then to contract to seal snuggly around the user's neck, essentially separating the environment inside the hood (1001)—an internal volume in which resides the user's head—from the environment outside the hood (1001).

In the embodiment shown in FIG. 1 the hood (1001) is supplied oxygen from two compressed gas cylinders (3004a) and (3004b) which jointly comprise an oxygen source. While in other embodiments, other oxygen sources, such as solid state chemical oxygen generators, are used, the depicted embodiment utilizes two compressed gas cylinders (3004a) and (3004b) which is typical for a PBE. The first cylinder (3004a) will be intended to primarily supply till gas for the hood to bring the hood to an initially selected positive pressure. The second cylinder (3004b) will provide a lower rate of oxygen gas and is primarily intended to supply oxygen at a rate roughly consistent with the expected use rate of a human user using the hood.

In the depicted embodiment, each of the cylinders (3004a) and (3004b) is attached to an associated micro regulator (3003a) and (3003b) for controlling release of oxygen from the cylinder (3004a) and (3004b) through regulation of the flow rate thereof. To start the flow of oxygen from the cylinders (3004a) and (3004b) prior to donning the hood (1001), a user operates an actuator, which in an embodiment is a spring biased pin that punctures a disk of the cylinders (3004a) and (3004b) to release the compressed gas contained therein into the regulator (3003a) or (3003b).

In an embodiment, the cylinders (3004a) and (3004b) initially are pressurized to about 3000 psig, and each contains about 18 liters of oxygen gas. The oxygen gas will typically be aviator's grade as compared to other grades of oxygen but that is not required for functionality (but may be required by regulation).

The hood (1001) may include one or more purification devices, which may include but are not limited to, particulate filtration or chemical purification, such as catalytic oxidation or adsorption. This may comprise a solid chemical substrate that chemically adsorbs or otherwise separates carbon dioxide from the gas drawn from the internal hood (1001) volume. Carbon dioxide may be removed from within the hood (1001) because of the constant enrichment with carbon dioxide of the gas within the internal hood (1001) volume due to the user's respiration. In an embodiment this comprises a form of lithium hydroxide adsorbent such as sheets or granules.

The two different cylinders (3004a) and (3004b) will typically each be provided with regulators having different flow rates so that they can each meet the requirements of the specific purpose of the cylinder. However, in an alternative embodiment, only the second cylinder (3004b) or first cylinder (3004a) will be supplied with a regulator. Commonly if only one regulator is provided it will be a regulator (3003b) for the second cylinder (3004b).

The first cylinder (3004a) will typically be designed to provide for rapid inflation of the hood (1001) to operating pressure. As such, the first regulator (3003a) will typically have a relatively high flow rate compared to the second regulator (3003b). In particular, the first regulator (3003a) will typically be designed to fully inflate the hood (1001) in less than 30 seconds. The cylinders (3004a) and (3004b) will typically deliver around 6-9 liters of oxygen to the hood (1001) in the first 20 seconds, therefore the flow rate of the first regulator (3003a) will typically be around 15-27 liters/per minute and often around 20 liters/per minute.

As indicated above, both cylinders (3004a) and (3004b) will typically have around 18 liters of oxygen which means that not all the oxygen in a single tank is necessary for inflation. However, as the regulator (3003a) will typically not be able to cut back on the rate after the hood (1001) is inflated, increased rate at the beginning will generally be accepted to deal with time for the user to don the breathing apparatus (1000) as inflation will typically begin before the breathing apparatus (1000) is placed over the head to making donning simpler and to avoid concerns of placing the head in the hood prior to inflation (and lack of oxygen therein).

The second regulator (3003b) will typically supply make up oxygen for the hood (1001) as oxygen is consumed by the user's breathing. In an embodiment, the second regulator (3003b) allows an oxygen flow rate in the range of about two liters per minute to about six liters per minute.

It should be recognized that the value of the regulator is that the regulators (3003a) and (3003b) allow for the more effective use of oxygen. Specifically, the regulators (3003a) and (3003b) provide increased useful life to the extent that they result in a sufficient reduction of oxygen waste, that the weight of the oxygen loss reduction is greater than the weight of the regulators. That is, the amount of oxygen in the tanks may be reduced by the weight of the regulators, but the regulated flow provides for oxygen supply from that reduced amount for the same or greater time than is provided by the increased weight of oxygen without the regulators being used.

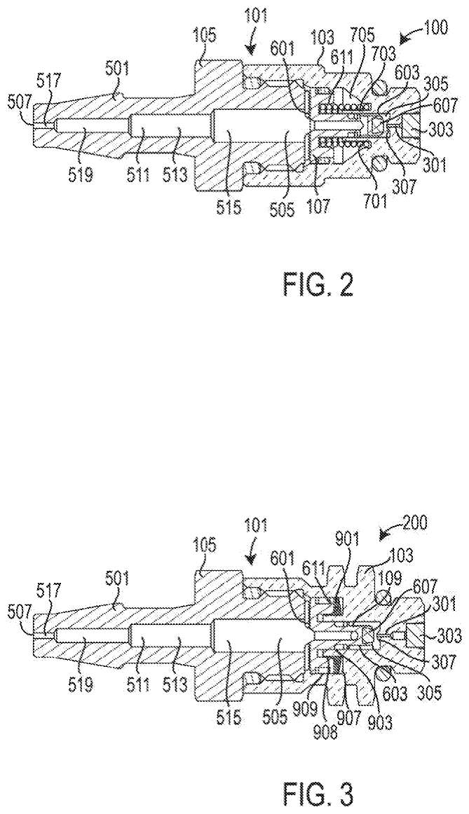

FIGS. 2 and 3 provide for a number of embodiments of microregulators which can supply for effective regulation with very little weight. FIG. 2 shows a microregulator (100) utilizing a micro compression spring (701) for regulation while FIG. 3 shows a microregulator (200) utilizing a series of wave washers (901) for regulation. Either of microregulator (100) or microregulator (200) may be used as regulator (3003a) and/or regulator (3003b) While the biasing members being different does provide for some different structure, FIGS. 2 and 3 share a number of common parts. In the FIGS, common numbers represent common parts. Specifically, both regulators (100) and (200) each comprise a housing (101) which is generally comprised of two separable components (103) and (105). The back housing (105) is typically designed to interface with the hood (not shown) so that oxygen is supplied from the tank (not shown) and through the exit orifice (517) to enter the hood. This oxygen comes through entrance orifice (303), into channel (301) and the hollow interior (305) of the front housing (103), and exits into the channel (511) and ultimately the exit orifice (517).

The back housing (105) is attached to the opposing side of the front housing (103) to entrance orifice (303). As such, it effectively closes the hollow interior (305). The back housing (105) includes a hollow stem (501) which is designed to interface with a tube, directly with the hood (not shown), or with another structure where the oxygen flow will be provided to the hood. The channel (511) of the stem (501), therefore, is open on one end (505) to the hollow interior (305) of the back housing (103).

The opposing end (507) comprises exit orifice (517). The channel (511) in the embodiment of FIGS. 2 and 3 is stepped so that the exit orifice (517) forms the end of the narrowest portion of the channel (511) and comprises the first step. The channel (511) then expands to section (519), expands again to section (513), and expands again to section (515) which includes the open end (505).

Within the hollow interior (305) of the front housing (103), there is included the valve piston (107) and (109). The specific shape of the valve piston (107) and (109) depends on the embodiment as their shape will generally be altered to correspond to the biasing mechanism (701) or (901) being used. However, the valve pistons (107) and (109) are similar in that they both provide the same function of moving back and forth against a biasing system to regulate the flow of gas from the channel (301) and entrance orifice (303) into the hollow interior (305) and the channel (511). Further, both valve pistons (107) and (109) are of a general “T” shape with a larger piston face (601) facing the back housing (105) and an extended shaft (603) opposing. The larger piston face (601) acting to provide a larger surface for the flowing gas to push against the end of the extended shaft (603) resulting in the regulation action.

Flow from the entrance orifice (303) will typically be controlled by the movement of the piston (107) and (109) and specifically the extended shaft (603). The extended shaft (603) can move generally linearly (left and right across the page in FIGS. 2 and 3) and will variably contact a seat (307) with the opposing seat (607). When the two seats (307) and (607) are in contact, oxygen flow from the entrance orifice (303) is generally inhibited as the pressure of the oxygen in the channel (511) pushing rightward in FIG. 2 or 3 against the piston face (601) is greater than the pressure in the channel (301) in combination with the force of the biasing mechanism (701) or (901) which will cause the flow to cease.

As the pressure in the channel (511) decreases from flow exiting the channel (511) via the exit orifice (507), this rightward pressure on the piston face (601) decreases causing the piston (107) or (109) to move leftward allowing additional gas to flow from channel (301). As this flows into channel (511) the corresponding increase in pressure in chamber (515) causes the piston (107) or (109) to again move rightward reducing the flow.

It should be apparent from the above that the movement of the piston (107) or (109) in conjunction with the pressure of the gas on piston face (601) will essentially result in an equilibrium state where the pressure in chamber (515) and the biasing force of the biasing member (701) or (901) are equaled at a specific flow of gas from the entrance orifice (303). This, in conjunction with elements of the stepped nature of channel (511) sets the pressure of the gas flowing from exit orifice (507)

The seats (607) in the regulators (100) and (200) will typically be different from seats in the same position on larger regulators. In larger regulators, the seat (607) will typically comprise a plastic or rubber insert so that the seat (607) will form a seal with the flat top and slanted sides of the conical frustum which forms the seat (307). However, in a particularly small regulator (100) and (200) making such an insert (and inserting it) is very difficult. Thus, while it is not required, the seat (607) is typically machined from the same metal as the piston (107) or (109) with no insert. The seat (307) will typically be a conical frustum so the flat face of the seat (307) will form a metal to metal seal against the seat (607). As the regulator (109) and (107) is so small, so long as it is well machined, this surface to surface contact will generally prohibit gas flow when the pressure on surface (601) is sufficiently high.

As indicated above, regulation is provided via a biasing member (701) or (901) which serves to bias the valve piston (107) or (109) toward an open position. Thus, when gas pressure is present in chamber (515) the pressure will push against the face (601). If the pressure is sufficient, the piston (107) or (109) will move to position the two seats (307) and (309) against each other. However, when the piston (107) or (109) is in this position gas cannot flow to the chamber (515) from the channel (303).

The biasing member (701) or (901) is typically positioned so as to push against the lower surface (611) of the top of the “T” shape of the piston (601). In FIG. 2, this is against an interior opening to help constrain the narrower spring (701) while in FIG. 3 it is on the wider portion of the “T” as the disk spring (901) is typically wider.

If the biasing force is sufficient, the piston (107) or (109) will move and open the gas channel (301) by unseating the seats (307) and (607). Once gas enters the hollow interior (305) it will flow to the chamber (515). As the gas in chamber (515) is somewhat slow to leave due to the gradually restricting shape of channel (511), the gas will serve to push the face (601) of piston (107) or (109) back toward the channel (301) and the reseating of (307) and (607). This movement is resisted by the biasing member (701) or (901).

The equilibrium position will generally result in some gas from entrance orifice (303) arriving in a steady stream as the same pressure (amount) is lost from the chamber (515) through the channel segments (513) and (519) and out the exit orifice (517). The results is that the pressure of the gas in chamber (515), is reduced compared to the pressure that oxygen is supplied via the entrance orifice (301) due to the gas in chamber (515) having a greater surface area to push against compared to gas in the narrow channel (301). The specific pressure of the released gas is typically based on the pressure in the oxygen tank and the biasing force supplied by the biasing member along with the specific size of the various chambers (515), (513), (519) and (301) and orifices (517) and (301).

In FIG. 2, the biasing member comprises a compression coil micro spring (701). Use of coil springs in regulators has been carried out in larger regulators. However, in larger regulators the spring is generally constrained in a housing between an inner wall (703) surrounding the path through which the extended leg of the piston will travel, and an outer wall contacting the outer surface of the spring coil. The outer wall typically is used to keep the spring from bulging outward when compressed because coil springs are typically quite thin in cross section of the coil. In the embodiment of FIG. 2, there is the inner wall (703) but no outer wall as the position of an outer wall has been replaced by slanted surface (705) arranged at a distance from the coil of spring (701). This is done because machining of an inner and outer wall structure at this size is not commercially feasible using current machining techniques as the coil cross section is too small for desired machining methods. Using a slant wall (705) is relatively easy to machine and has proven functional to support the spring (701).

In the regulator (200) of FIG. 3, the coiled spring is not present and a disk spring or stack of wave washers (901) is used instead. This is typically preferred as the small size of the regulator (200) is well suited to the small available stroke typically offered by stacked wave washers (901). The location (907) of the wave washers (901) does not need to be as deep as for coil spring (701) and is typically wider. However, as the wave washers may be able to move relative to each other, inclusion of an inner wall (908) and outer wall (909) both in contact with the inner and outer surfaces, respectively, of the washer stack (901) is desirable to retain the washers. However, as the stacked washers are much larger in cross section, machining of these walls is much more feasible than it typically is for the coil spring (701).

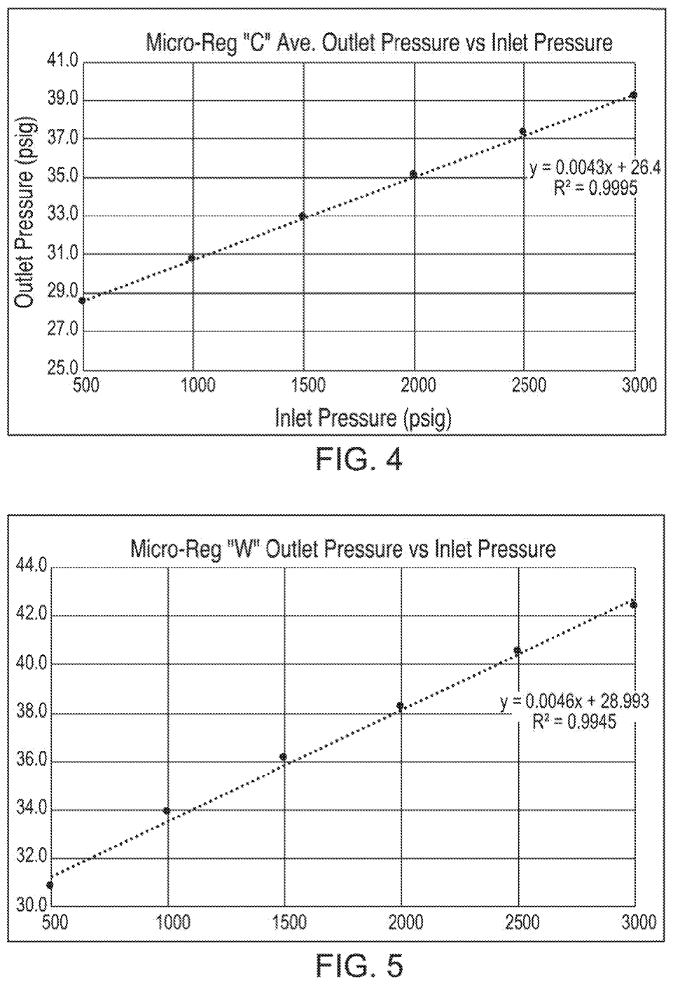

Use of the regulator (100) or (200) will typically connect between the oxygen tanks and the hood. As can be seen in FIGS. 4 and 5, the regulators (100) and (200) can be used with relatively high input pressure to produce desired output pressures in the range of use for such a regulator in a PBE. Typically two different regulators will be used with the oxygen tanks, one will be used with the first oxygen tank to quickly fill and pressurize the hood, the second will be used to provide for a steady stream of gas over time. It is important for a regulator in a PBE, to supply gas in a more efficient manner (based on effective life that the gas in the hood remains breathable) to make up from the loss of gas source to counteract the weight of adding the regulator.

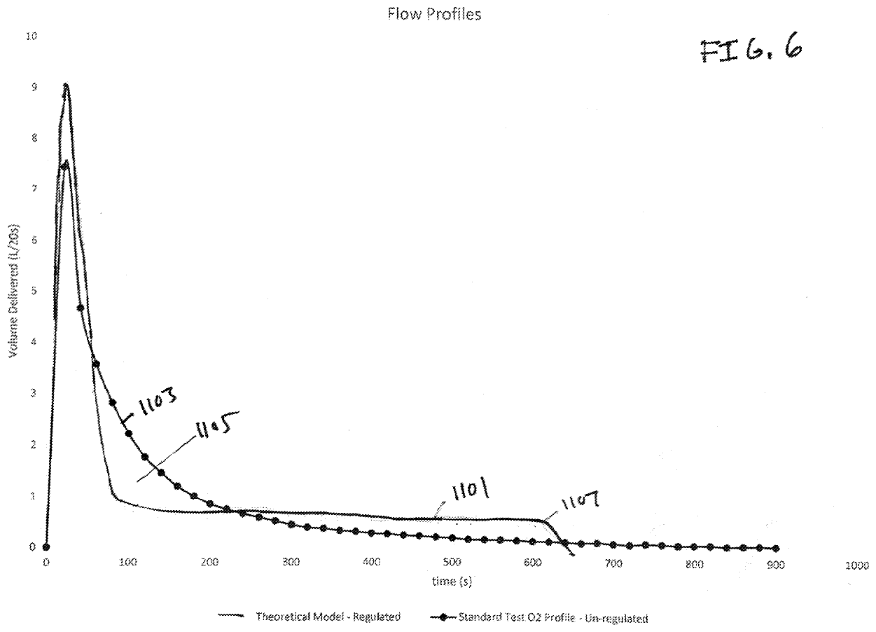

FIG. 6 provides for a chart showing comparison of a regulated hood filling and supply pattern (1101) compared to an unregulated filling and supply pattern (1103). As can be seen, in the regulated pattern, initial inflation can actually occur quicker, the first tank is exhausted, and the flow rapidly falls off to a relatively constant amount which is maintained for essentially a full ten minutes (600 seconds) giving the hood a good operational life of around 10 minutes. In the unregulated case, the inflation is a little slower, and the fall off rate is more curved. In the area (1105) the unregulated system is effectively providing too much gas and the rate rapidly falls below the regulated amount at around 240 seconds (4 minutes). While gas flow is likely still sufficient after that to maintain inflation, the operational life is likely less than the 10 minutes of the regulated system (1101). Thus, the regulators would appear to provide for increased operational life countering their weight of inclusion.

The regulated PBE will generally be stored prior to use in a vacuum sealed barrier pouch that is intended to be opened only at the time the PBE will be used, such as when needed to be donned quickly in an emergency. Such sealed storage maintains the cleanliness of the apparatus PBE.

To use the PBE shown in FIG. 1, a user will generally remove the PBE from the vacuum-sealed barrier pouch by tearing open the vacuum-sealed pouch and removing the PBE. The user operates an actuator which begins the flow of oxygen through the first regulator and into the hood to inflate the hood. The user will generally place both hands inside a neck seal opening and slide the opening over the user's head so the user's head is positioned inside the hood. The user then removes the user's hands from the opening allowing the neck seal to seal securely around the user's neck.

After it has been donned, the first tank will typically be rapidly depleted of oxygen and the flow will primarily be from the second tank. This is the flat portion of FIG. 6. Because the flow is regulated, this flow is much flatter and therefore more consistent than the flow from an unregulated tank. The user can breathe normally inside the hood. When the second oxygen source is depleted, the hood will start to rapidly deflate (beginning at point (1107) on FIG. 6) as there is basically no more oxygen available. This deflation indicates that the hood needs to be removed.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “orthogonal” are purely geometric constructs and no real-world component or relationship is truly “orthogonal” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A breathing apparatus for providing a user with a breathable atmosphere, such breathable atmosphere being generally isolated from a potentially hazardous external environment, said apparatus comprising:
a hood capable of surrounding a user's head, said hood having an internal volume therein;
a first oxygen source including a first amount of pressurized oxygen to said hood via a first regulator, said first regulator providing a first rate of said first amount of oxygen; and
a second oxygen source including a second amount of pressurized oxygen to said hood via a second regulator, said second regulator providing a second rate of said second amount of oxygen;
wherein, said first rate is greater than said second rate;
wherein, said first amount of oxygen is depleted before said second amount of oxygen; and
wherein, said second rate supplies sufficient oxygen from said first tank to allow a human to breathe from said hood for at least 600 seconds.
